(19) United States
(12) Patent Application Publication
(10) Pub. No.: US 2004/0066453 A1
(43) Pub. Date: Apr. 8, 2004

(54) Imaging system

(76) Inventors: Matheus Adrianus Dam, Groningen (NL); Martinus Theodorus M. Knaven, Groningen (DE); Eghert Schroten, Hardenberg (NL)

Correspondence Address: MERCHANT & GOULD PC, P.O. BOX 2903, MINNEAPOLIS, MN, 55402-0903, US

(21) Appl. No.: 10/343,594

(22) PCT Filed: Jul. 31, 2001
(86) PCT No.: PCT/NL01/00585

(30) Foreign Application Priority Data
Jul. 31, 2000 (NL) 1015841

(51) Int. Cl. G02F 1/167

(52) U.S. Cl. 348/162

(57) ABSTRACT

An imaging system, comprising a foil, which is manufactured from a electrically insulating foil material, the foil being provided with a plurality of channels of a first kind which are substantially perpendicular to a foil surface, in each channel of the first kind at least one electrophoretic medium of a first kind being included, a visual exterior of the electrophoretic medium of the first kind being dependent on an electric field applied over the electrophoretic medium of the first kind, characterized in that the foil material is optically transparent and each channel of the first kind extends from a foil surface located on a control side over a part of the thickness of the foil in the direction of a foil surface located on the view side.

The invention relates to an imaging system, comprising a foil, which is manufactured from an electrically insulating foil material, the foil being provided with a plurality of channels of a first kind which are substantially perpendicular to a foil surface, in each channel of the first kind at least one electrophoretic medium of a first kind being included, a visual exterior of the electrophoretic medium of the first kind being dependent on an electric field applied over the electrophoretic medium of the first kind.

Such a system is known from DE 19927361 A1. The electrophoretic medium comprises a fluid in which charged or polar particles are included. These particles move through the fluid in the channel or change an orientation as a result of an electric field, applied over the electrophoretic medium. Through this displacement or change of orientation, a visual exterior of the electrophoretic medium is changeable. A predetermined image can be formed on the view side of the system by changing the visual exterior of the electrophoretic medium in channels' selected to that end. In use, the system is therefore provided with electrodes located on the control side, each arranged to generate an individual electric field. In use, the system is also provided with an electrode disposed on the view side, which is foil-shaped and transparent and extends over the entire surface of the foil located on the view side. In such a situation, this electrode also often serves for sealing the channels so that the electrophoretic medium on the view side cannot flow out of the channels. For a good quality of the image to be observed, during use, on the view side, the channels are located as closely together as possible. Observed from the view side, preferably a largest possible part of the surface is occupied by the channels and a smallest possible part of the surface is occupied by foil material lying between the channels. This implies that relatively little foil surface is available for applying, for instance with the aid of glue, the sealing layer which ensures that the medium does not flow out of the channels. This hinders the application of the sealing layer. A layer once applied is susceptible to damage in the sense that adhesion of the layer to the foil takes place on very small surfaces and, therefore, does not form a reliable adhesion. As the view side is exposed to the free surroundings, the system can, on this side, easily be damaged during use. Accordingly, an additional drawback of such a system is that there is a relatively great risk that the layer applied on the view side, which is transparent, seals the channels, and often also functions as an electrode, detaches from the foil so that the electrophoretic systems on the view side will flow from the channels. In such a situation, the system is no longer repairable.

It is an object of the invention to provide an electrophoretic imaging system in which the risk of the electrophoretic medium flowing away by the withdrawal or detachment of the layer applied to the foil surface on the view side is minimal.

This object is achieved with the system according to the invention, which is characterized in that the foil material is optically transparent, each channel of the first kind extending from a foil surface of the foil located on a control side of the system opposite a view side of the system over a part of the thickness of the foil in the direction of a foil surface of the foil located on the view side of the system.

This offers the advantage that each channel of the first kind is only provided with an opening on the control side. In other words, in the direction of the view side, the channels are blind. As the foil material is optically transparent, the visual exterior of the electrophoretic medium in each channel can be observed from the view side. A transparent layer which is arranged to function as an electrode, can, moreover, be properly applied to the foil layer as much foil surface is available to have the layer adhere to the foil, for instance with the aid of glue. When such an electrode, provided on the foil surface located on the view side, detaches in one way or the other, the electrophoretic medium of the first kind will not be able to flow from the channels on the view side. The fact is that the channels are blind on the view side. The system can, if required, be repaired by simply applying a new, transparent electrode layer to the foil surface located on the view side.

An embodiment of the system according to the invention is characterized in that the foil is also provided with a plurality of channels of a second kind, each channel of the second kind extending from the foil surface of the foil located on the view side of the system over a part of the thickness of the foil in the direction of the foil surface of the foil located on the control side of the system, the channels of the first and the second kind being distributed in the foil layer such that, viewing in a direction parallel to the axial direction of the channels, at least a minimal distance is available between at least a part of channel wall, closed in itself, of each channel of the first kind and at least a part of the channel wall, closed in itself, of each channel of the second kind, a direct fluid communication between each channel of the first kind and each channel of the second kind being excluded.

This offers the advantage that there is a possibility to also include an electrophoretic medium in the channels of the second kind, which involves the possibility of a combination of a good quality of the image to be observed, in use, on the view side, and a good adhesion of a layer to be applied on the view side, which layer seals the channels of the second kind. The fact is that, on the one hand, in the image to be formed in use, as observed in a direction parallel to the axial direction of the channels, the part of the control side visible through the foil material need not form part of the image, while, on the other hand, sufficient foil surface can be available on the view side for applying to this foil surface a layer sealing the channels of the second kind, after, naturally, an electrophoretic medium has been included in each channel of the second kind. In fact, as sufficient foil surface can be available on the view side, the layer sealing the channels of the second kind can sufficiently adhere to the foil surface with, for instance, glue. This minimizes the risk of withdrawal of this layer, so that the risk of the electrophoretic medium of the second kind flowing away is also small. Furthermore, this offers the additional advantage that, also on the control side, relatively much foil surface can be available for applying the layer sealing the channels of the first kind.

A yet more detailed embodiment of the system according to the invention is characterized in that in each channel of the second kind at least one electrophoretic medium of a second kind is included, a visual exterior of the electrophoretic medium of the second kind being dependent on an electric field applied over the electrophoretic medium of the second kind, a visual exterior of the electrophoretic medium of the second kind being different from a visual exterior of the electrophoretic medium of the first kind.

This offers the advantage that, in use, the images to be formed with the aid of a system according to this embodiment, can comprise more than one color, and, if so desired, even combinations of colors in the image to be formed can be observed from a distance. Additionally, such an embodiment offers an advantage when introducing the electrophoretic medium of the first kind into the channel of the first kind and the electrophoretic medium of the second kind into the channels of the second kind. This need not take place selectively with expensive and complicated equipment, but can, instead, be done in a simple and inexpensive manner by filling all channels ending up on the view side, in this case the channels of the first kind, in one step with the electrophoretic medium of the first kind, and all channels ending up on the control side, the channels of the second kind, in a different step with the electrophoretic medium of the second kind.

A yet more advantageous embodiment of the system according to the invention is characterized in that the channels of the first kind and/or the channels of the second kind are substantially conical.

This offers the advantage that the channels of the first and/or the second kind can be surrounded by more foil material, without, in the image to be formed in use, and viewed in a direction parallel to the axial direction of the channels, parts of the system visible through the foil material and located on the control side forming part of the image. As the channels of the first and/or the second kind can be surrounded by more foil material, the strength and the rigidity of the foil is greater than the strength and the rigidity of the foil which can offer an image quality comparable in this respect, but whose channel walls closed in themselves are parallel to the axial direction of the channels.

A further special embodiment of the system according to the invention is characterized in that at least one of the sealing layers is provided with projecting parts, which are positioned and designed such that in each channel sealed by the layer a projecting part is fittingly received and the electrophoretic medium in such a channel is enclosed between the foil material and the projecting part.

This offers the advantage that a glue to be possibly used can be applied to the sealing layer in a selective manner such that there is hardly any glue available on the projecting part prior to the sealing layer being applied to the foil surface. The electrophoretic medium partly enclosed by the sealing part is therefore not mixed and clouded with glue.

The invention will now be elucidated with reference to a drawing. In the drawing:

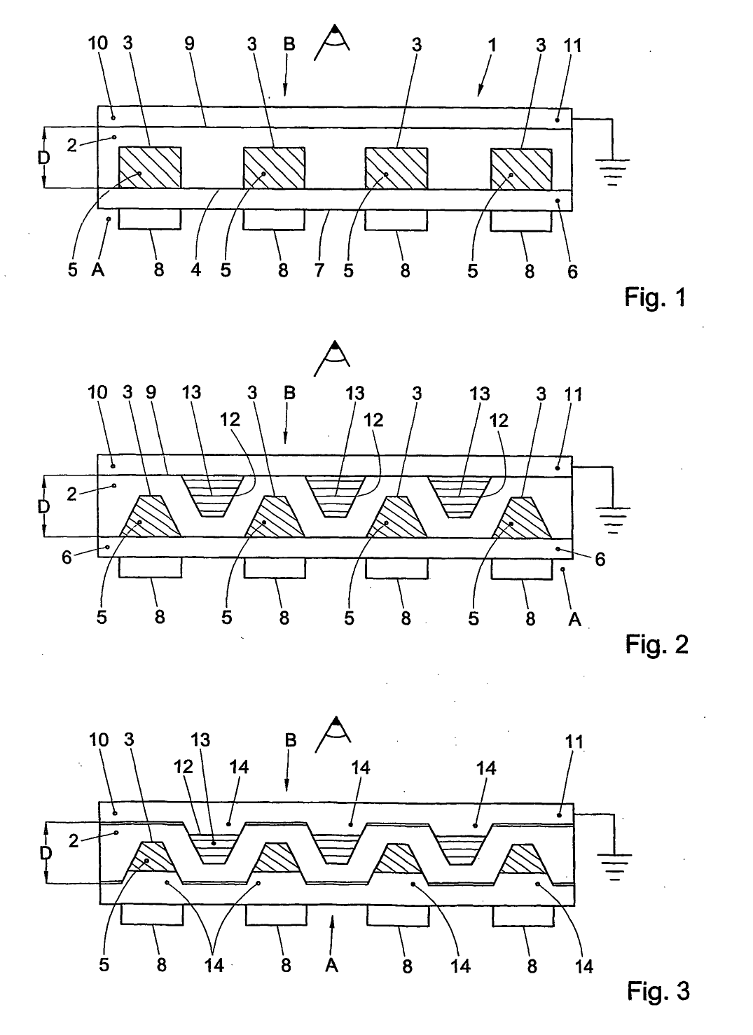

FIG. 1 schematically shows a cross section of a first embodiment of the system according to the invention;

FIG. 2 schematically shows a cross section of a second embodiment of a system according to the invention; and

FIG. 3 schematically shows a cross section of a third embodiment of a system according to the invention.

In FIG. 1 is schematically shown a cross section of an imaging system 1, comprising a foil 2, which is manufactured from an electrically insulating and optically transparent foil material. The foil layer 2 is provided with a plurality of channels of a first kind 3. Each channel of the first kind 3 extends from a foil surface 4 located on a control side A of the system over a part of the thickness D of the foil. This control side A of the system lies opposite a view side B of the system 1. An axial direction of each channel of the first kind 3 is substantially perpendicular to the foil surface 4. In each channel of the first kind 3, an electrophoretic medium of a first kind 5 is included. A visual exterior of the electrophoretic medium of the first kind 5 is dependent on an electric field applied over the electrophoretic medium of the first kind 5. On its foil surface located on the control side A of the system the foil is provided with a sealing layer 6, sealing each channel of the first kind 3. The sealing layer 6 can, for instance, be glued to the foil surface 4 located on the control side. Further, on the surface 7 of the sealing layer 6 located on the control side A of the system, individual electrodes 8 are provided. On the entire foil surface 9 of the foil located on the view side B of the system, a foil-shaped and transparent layer 10 is applied. In this example, this layer 10 also functions as electrode 11. By means of the electrodes 8, 11, located on both sides of the foil layer, an individual electric field can, in use, be applied over each channel of the first kind to form an image observable from the view side. The layers 6, 10, applied on both sides of the foil, can, as is indicated, be glued, but it is also conceivable that the layers are held against the foil by means of clamping. The layer 6, located on the view side, has to be transparent, but need not be colorless. The layer located on the control side is preferably optically non-transparent to ensure that, in use, observation of the image to be formed on the view side is not disturbed by the visibility of the electrodes located on the control side and other regulating means (not shown). In an embodiment as shown in FIG. 1, the quality of the image to be formed in use is better as the amount of the foil material between the channels decreases to a minimum. The fact is that in that case, viewing in a direction parallel to the axial direction of the channels, a minimum of foil material is visible between the channels forming part of the image to be formed. On the other hand, this minimum will be limited by a minimum amount of foil surface 4, necessary on the control side, to which to apply the layer 6, by gluing and/or clamping.

In FIG. 2, a schematically shown cross section of a second embodiment of a system 1 according to the invention, the foil 2 is provided with a plurality of channels of a first kind 3. Each channel of the first kind 3 extends from a foil surface 4, located at a control side, over a part of the thickness D of the foil. An axial direction of each channel of the first kind is substantially perpendicular to the foil surface 4. In each channel of the first kind 3, an electrophoretic medium of a first kind 5 is included. A visual exterior of the electrophoretic medium of the first kind 5 is dependent on an electric field applied over the electrophoretic medium of the first kind 5. The foil 2 is also provided with a plurality of channels of a second kind 12. Each channel of the second kind 12 extends from a foil surface 9, located on a view side, over a part of the thickness D of the foil 2. An axial direction of each channel of the second kind is substantially perpendicular to the foil surface 4, 9. In each channel of the second kind 12, an electrophoretic medium of a second kind 13 is incorporated. A visual exterior of the electrophoretic medium of the second kind 13 is dependent on an electric field applied over the electrophoretic medium of the second kind 13. Viewing in a direction parallel to the axial direction of the channels 3, 12, at least a minimal distance is available between at least a part of a channel wall, closed in itself, of each channel of the first kind 3 and at least a part of a channel wall, closed in itself, of each channel of the second kind 12. In other words, viewing in a direction parallel to the axial direction of the channels 3, 12, the channels 3, 12 may overlap, but not such that a channel wall, closed in itself, of a channel of the first kind 3 coincides in its entirety with a channel wall, closed in itself, of a channel of the second kind 12. A direct fluid communication between each channel of the first kind 3 and each channel of the second kind 12 is evidently excluded by the foil material of the foil 2 between the channels 3, 12. In each channel of the second kind 12, an electrophoretic medium of the second kind 13 is included. To the foil surface 9, located on the view side, a layer 10 is applied. This layer 10 is optically transparent and seals each channel of the second kind 12. Furthermore, this layer 10 is arranged to also function as electrode 11. To the foil surface located on the control side a layer 6 is applied. The layer 6 seals each channel of the first kind 3. The layer 10 can, for instance by gluing, adhere to the foil layer 2; in this embodiment, sufficient foil surface 9 can be available on the view side to have adhesion take place on it. The layer 6 can, likewise by gluing, adhere to the foil layer 2; in this embodiment, sufficient foil surface 4 can be available also on the view side to have adhesion take place on it. It is less obvious, but not inconceivable that, instead of or in addition to gluing, clamping is applied. A visual exterior of the electrophoretic system of the second kind 13 is also dependent on an electric field applied over the electrophoretic medium of the second kind 13, a visual exterior of the electrophoretic system of the second kind 13 being different from a visual exterior of the electrophoretic system of the first kind 5. This renders it possible that, in use, the images to be formed with the aid of a system 1 according to this embodiment contain more than one color. For instance, it is also possible that the first electrophoretic medium 5 can adopt a visual exterior that is either red or transparent, and the second electrophoretic medium 13 can adopt a visual exterior that is either green or transparent. The layer 10, sealing the channels of the first kind, can, for instance, have a blue color so that it is possible that these three adjacent channels can form combinations of the essential colors in an image to be observed from a distance. This increases the number of possible colors that can be observed from a distance in the image to be formed. In the embodiment shown in FIG. 2, the channels of the first kind 3 and the channels of the second kind 12 are each designed to be conical.

In FIG. 3 is schematically shown a cross section of a third embodiment of a system 1 according to the invention. In this embodiment, both the layer 10, located on the view side, and the layer 6, located on the control side, are provided with projecting parts 14, which are positioned and designed such that in each channel 3, 12, sealed by a layer 6, 10, a projecting part 14 is fittingly received. The electrophoretic medium 5, 13 in such a channel 3, 12, is, therefore, enclosed between the foil material of the foil 2 and the projecting part 14. When a glue to be optionally used is applied to a side to be glued of a layer 6, 10 to be applied, such that the projecting parts 14 are spared of glue before the layer, during manufacture, is applied to the respective foil surface 4, 9, the respective electrophoretic medium 5, 13 in the channels 3, 12, sealed by the respective layer 4, 9, will not be mixed and/or clouded by the glue.

Naturally, the system 1 can be provided with further regulating means (not shown) for regulating, in each channel 3, 12, a visual exterior of the electrophoretic medium 5, 12.

In a known manner, the channels 3, 12 can be provided in the foil 2, for instance by means of selective etching. With the aid of a similar method, the layer 6, 10 can be provided with the projecting parts 14. In this case, evidently, a part of the layer is selectively etched away in such a manner that the projecting parts 14 remain on a layer which, after etching, is somewhat thinner than the layer before etching.

The invention is not in any way limited to the exemplary embodiments shown. For instance, in a variant not shown various foils 2, provided on one or both sides with blind channels, can be brought against each other. Between these foils 2, a transparent, channel-sealing layer can be applied, but the foils 2 can also be brought together such that they seal each other's blind channels. Also, the sealing foil surfaces can be provided with projecting parts at predetermined locations. The channels of the first kind and the channels of the second kind, and, optionally, channels of a third kind are preferably, viewing in a direction parallel to the axial direction of the channels, uniformly distributed. Apart from the cul-de-sac character, the shape of the channels 3, 12 can be determined freely.

The layer 6, located on the control side, sealing the channels of the first kind 3, can be designed to be unidirectionally electrically conductive in a direction substantially perpendicular to a surface of the sealing layer. Such a unidirectionally conductive layer is known from PCT NL 98/00341. This layer comprises channels, which are continuous, perpendicular to a surface of the layer, and filled with a conductive material. In this use, the distribution of the channels in this unidirectionally conductive layer is such that over each channel of the first kind 3, and if applicable, each channel of the second kind 12, a separate electric field can be applied. This unidirectionally conductive layer is also, albeit in a somewhat different design, commercially available.

All such variants are understood to fall within the scope of the invention.

1. An imaging system, comprising a foil, which is manufactured from an electrically insulating foil material, the foil being provided with a plurality of channels of a first kind which are substantially perpendicular to a foil surface, in each channel of the first kind, at least one electrophoretic medium of a first kind being included, a visual exterior of the electrophoretic medium of the first kind being dependent on an electric field applied over the electrophoretic medium of the first kind, characterized in that the foil material is optically transparent, each channel of the first kind extending from a foil surface of the foil located on a control side of the system opposite a view side over a part of the thickness of the foil in the direction of a foil surface of the foil located on the view side of the system.

2. A system according to claim 1, characterized in that the foil is provided on the control side with a sealing layer sealing each channel of the first kind.

3. A system according to claim 2, characterized in that the sealing layer is optically non-transparent.

4. A system according to claim 2 or 3, characterized in that the sealing layer is designed to be unidirectionally electrically conductive in a direction substantially perpendicular to a surface of the sealing layer.

5. A system according to any one of the preceding claims, characterized in that the foil is further provided with a plurality of channels of a second kind, each channel of the second kind extending from the foil surface of the foil located on the view side of the system over a part of the thickness of the foil in the direction of the foil surface of the foil located on the control side of the system, the channels of the first and the second kind being distributed in the foil layer such that, viewing in a direction parallel to the axial direction of the channels, at least a minimum distance is available between at least a part of the channel wall, closed in itself, of each channel of the first kind and at least a part of channel wall, closed in itself, of each channel of the second kind, a direct fluid communication between each channel of the first kind and each channel of the second kind being excluded.

6. A system according to claim 5, characterized in that in each channel of the second kind an electrophoretic medium of a second kind is included, a visual exterior of the electrophoretic medium of the second kind being dependent on an electric field applied over the electrophoretic medium of the second kind, a visual exterior of the electrophoretic medium of the second kind being different from a visual exterior of the electrophoretic medium of the first kind.

7. A system according to claim 6, characterized in that the foil is provided on the view side with an optically transparent sealing layer.

8. A system according to claim 7, characterized in that the sealing layer with which the system is provided on the view side comprises an electrode.

9. A system according to claim 7 or 8, characterized in that the sealing layer with which the foil is provided on the view side seals each channel of the second kind.

10. A system according to any one of the preceding claims, characterized in that the channels of the first kind and/or the channels of the second kind are substantially conical.

11. A system according to any one of claims 2-10, characterized in that at least one of the sealing layers is provided with projecting parts, which are positioned and designed such that in each channel sealed by the layer a projecting part is fittingly received and the electrophoretic medium in such a channel is enclosed between the foil material and the projecting part.

12. A system according to any one of the preceding claims, wherein the system is further provided with regulating means for regulating in each channel a visual exterior of the first or the second, or optionally the third electrophoretic medium.
